(19) United States
(12) Patent Application Publication
(10) Pub. No.: US 2008/0149036 A1
(43) Pub. Date: Jun. 26, 2008

(54) SELF-CLEANING PET LITTER BOX

(76) Inventor: Richard H. Emery, Lebanon, OH (US)

Correspondence Address: WOOD, HERRON & EVANS, LLP, 2700 CAREW TOWER, 441 VINE STREET, CINCINNATI, OH, 45202, US

(21) Appl. No.: 11/940,632

(22) Filed: Nov. 15, 2007

Related U.S. Application Data
(60) Provisional application No. 60/871,292, filed on Dec. 21, 2006.

(51) Int. Cl. A01K 1/01

(52) U.S. Cl. 119/166

(57) ABSTRACT

A self-cleaning pet litter box assembly for separation and removal of clumped material from clean litter material includes an open-top pet litter container for holding litter and being mounted for rotation on a substantially horizontal plane, a conveyor having an axis and an exit end, being positioned to extend into the container to contact litter within the container and rotating about the axis so as to separate clumped material from clean litter material and direct the separated-out clumped material away toward the exit end, and a drive mechanism operatively connected to at least one of the container and the conveyor to rotate the container.

The present application claims the filing benefit of U.S. Provisional Application Ser. No. 60/871,292, filed Dec. 21, 2006, the disclosure of which is incorporated herein by reference in its entirety.

### FIELD OF THE INVENTION

The present invention generally relates to pet litter box assemblies and, more particularly, to a self-cleaning pet litter box assembly wherein clumped material is separated from reusable clean litter material.

### BACKGROUND OF THE INVENTION

A large number of households have one or more animal pets. Domestic cats in particular are estimated to live in over thirty million homes all or most of the day. A litter box or the like is a necessity for such homes. In fact, basic rectangular-shaped litter boxes having a height of about four to five inches have been used for many years. While much development work has been expended in producing improved litter material to make it more absorbent, odor-free, dust-free, etc., very little change has occurred in the basic litter box itself. Those boxes being presently commercialized are remarkably similar to those of several years ago.

Maintaining pet litter boxes requires frequent cleaning and attention. This job is unpleasant due to odor. Strong odor and unsanitary conditions develop quickly if the pet litter box is not properly maintained on a frequent basis. Busy schedules and travel make proper attention to the pet litter boxes difficult.

Basic conventional litter boxes are popular simply because they have proven themselves effective. Cats are readily trained to use them. The biggest drawback associated with the conventional litter box is a need to periodically remove soiled litter material and replenish it with new litter material. Any cat owner will attest to the fact cats are fastidious, such that they will not use a litter box that contains what they consider to be an excessive amount of soiled litter material. The cat owner can at that point simply dump the full contents of the litter box into the trash or otherwise dispose of it. This, of course, is wasteful and expensive in that a substantial amount of unsoiled litter material is being disposed of along with the soiled litter material. It is more common for the cat owner to try to segregate soiled from unsoiled litter material. This is possible because most litter materials are designed to clump when wetted. Various scoops are sold for this purpose. However, the task of scooping clumped soiled litter material and cat feces from a litter box is still an arduous and unpleasant task.

The problem with cleaning and keeping the contents of a litter box in a state that is acceptable to the cat is well recognized. Several attempts have been made over the years to remedy the problem. U.S. Pat. Nos. 4,846,104, 5,048,464, and 5,662,066, for example, are directed to self-cleaning litter systems wherein specially configured spherical or cylindrical containers rotate in a manner to separate clumped from unclumped (i.e., clean) litter material. U.S. Pat. Nos. 4,574,735, 5,048,465 and 5,477,812 are also directed to self-cleaning litter systems. The systems described by these patents may have a stationary litter container and a rake or comb-type device that periodically moves through litter in the container to separate out clumped material. The clumped material is directed to a separate disposal system as part of the process. In other cases, a rotatable member may convey clumped material away from the container. Such rotating member, however, may require a scoop member or the like to feed clumped material into the range of motion of the rotating member, which adds to the complexity of the system or the overall size thereof.

U.S. Pat. No. 5,931,119 is directed to a self-cleaning litter system including a horizontally rotatable litter container and a raking mechanism for gathering and removing animal waste from the rotating litter container and depositing the waste into a collection container. The raking mechanism is moved from a position in contact with the litter material to a parked position clear of the litter material after depositing the gathered waste into the collection container. U.S. Pat. Nos. 6,234,112 and 6,401,661 are also directed to self-cleaning litter systems but share some of the drawbacks of other known devices.

Conventional self-cleaning cat litter boxes either cycle abruptly after a sensor has determined that a cat has been in the device, or have a relatively short amount of time to filter the litter. These self-cleaning litter boxes need to minimize cleaning time so that they are available for the next use. Conventional self-cleaning litter boxes attempt to relatively quickly clean the litter by raking, scooping or vertically rotating. The conventional relatively rapid cleaning process of raking, scooping or rotating vertically damages the clumps, causes dust to become airborne, and most importunately may not make it safe for cats to be in the device during the cleaning process.

Known self-cleaning litter systems are generally either too complex, too expensive or simply do not work for one reason or another. It is evident that cat owners recognize the drawbacks of known litter boxes. It is surmised that most would be willing to invest added money into a self-cleaning pet litter box if it truly worked.

There is clearly an ongoing need for an improved pet litter box cleaning system. Any improvement must take into account the cat's habits and needs, it must not increase the cat owner's cleaning efforts or add to the unpleasantness of the task, it should as conspicuous as possible and minimize undesirable destruction of solid pet waste.

### SUMMARY OF THE INVENTION

The present invention overcomes the foregoing and other shortcomings and drawbacks of a self-cleaning pet litter box assembly heretofore known. While the invention will be described in connection with certain embodiments, it will be understood that the invention is not limited to these embodiments. On the contrary, the invention includes all alternatives, modifications and equivalents as may be included within the spirit and scope of the present invention.

These and other shortcomings in the prior art have been addressed by this invention which, in one embodiment, includes a self-cleaning pet litter box assembly for separation and removal of clumped material from clean litter material. The assembly includes an open-top pet litter container for holding litter and being mounted for rotation on a substantially horizontal plane, and a drive mechanism operatively connected to the container to rotate the container. The assembly also includes a conveyor having a longitudinal axis and an exit end, and which is positioned to extend into the container to contact litter within the container. Rotation of the conveyor is configured to separate clumped material from clean litter material and to direct the separated-out clumped material away toward the exit end.

The conveyor may be frustoconically or cylindrically shaped or have any other geometrical or compound geometrical shape. The conveyor may additionally or alternatively include an entrance end that is disposed opposite the exit end and which extends effectively between a center and a side wall of the container. A flight, such as a helically shaped flight, may protrude from an inner surface of the conveyor for conveying the clumped material toward the exit end of the conveyor. The flight may have a height that varies along at least a portion of a length of the conveyor which may, for example, be less proximate the entrance end than in other portions of the conveyor. The conveyor may include a plurality of apertures that are configured to retain the clumped material while permitting clean litter material to pass there through. Alternatively or additionally, the conveyor may have cup elements disposed proximate the entrance end and configured to pick up the clean litter material and deposit it onto clumped litter material within the conveyor.

In another embodiment, a method of automatically separating and removing clumped material from clean litter material includes rotating an open top litter container to bring the clumped and clean litter material into engagement with a conveyor. The conveyor is rotated to direct the clumped material and clean litter material away from the container and the clean litter material is directed through a plurality of openings of the conveyor back and into the container.

Advantageously, the self-cleaning pet litter box assembly of the present invention provides conveyance of the clumped waste material away from the litter container for disposal while minimizing the chance of destroying the clumped material in the process. This is accomplished by forcing most of the clean litter material into the conveyor and gently filtering the clumped material from clean litter along a relatively long path and for a relatively long time. Moreover, this is facilitated by movement of at least most components that come in contact with the clumped material.

The slow and continuous cleaning process of this invention minimizes dust, is gentle on clumps, is always available for the cats use and always safe for the cat to be in the device. The filtering process can take several minutes or more, which will insure thorough cleaning of the litter, without slowing the horizontal rotation of the litter container. The fact that the device is always available to cats means that it is ideal for multiple cat households. Moreover, and unlike the case with conventional devices, the cat will not be frightened by the sudden movement and noise caused by the cleaning cycle of conventional sensor activated self-cleaning litter boxes, which could frighten the cat and discourage future use of the litter box.

The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention provided above, and the detailed description of the embodiments provided below, serve to explain the principles of the invention.

FIG. 1 is a perspective view of an embodiment of a self-cleaning pet litter box assembly;

FIG. 2 is a top view of the pet litter box assembly of FIG. 1 further showing clumped material being processed by the device;

FIG. 2A is a view similar to FIG. 2 showing a different embodiment of a pet litter box assembly;

FIG. 3 is an elevation assembly drawing of the assembly of FIG. 1;

FIG. 4 is a partially exposed perspective view of a conveyor of the assembly of FIG. 1;

FIG. 5 is an enlarged perspective view of a section of the entrance end of the conveyor of FIG. 4;

FIG. 6 is partially exposed elevation view taken along line 6-6 of FIG. 2;

FIG. 7 is a partially exposed elevation view taken along line 7-7 of FIG. 2;

FIG. 8 is a top view of an alternative embodiment of a self-cleaning pet litter box assembly;

FIG. 9 is an elevation view of an alternative embodiment of a self-cleaning pet litter box assembly;

FIG. 10 is a partial cross-sectional view taken along line 10-10 of FIG. 9;

FIG. 11 is a top view similar to FIG. 8 showing a different embodiment of a pet litter box assembly; and

FIG. 12 is a partially broken top view of another embodiment of a conveyor different from those of the embodiments of FIGS. 1-11.

### DETAILED DESCRIPTION OF THE INVENTION

A self-cleaning pet litter box assembly and corresponding method of use in accordance with the principles of the invention are described in detail in the following paragraphs and with reference to the drawings. The assembly is described with reference to its use by cats. While other domestic animals can be trained to use the pet litter box assembly and such other uses are contemplated, the need for the assembly by cat owners is greatest and for this reason the description which follows is directed to cat usage. As used throughout this specification, clumped material is used to mean pet feces and soiled pet litter that has clustered to form a clump. Clean litter material includes fresh pet litter and substantially clean free-flowing pet litter, which is reusable.

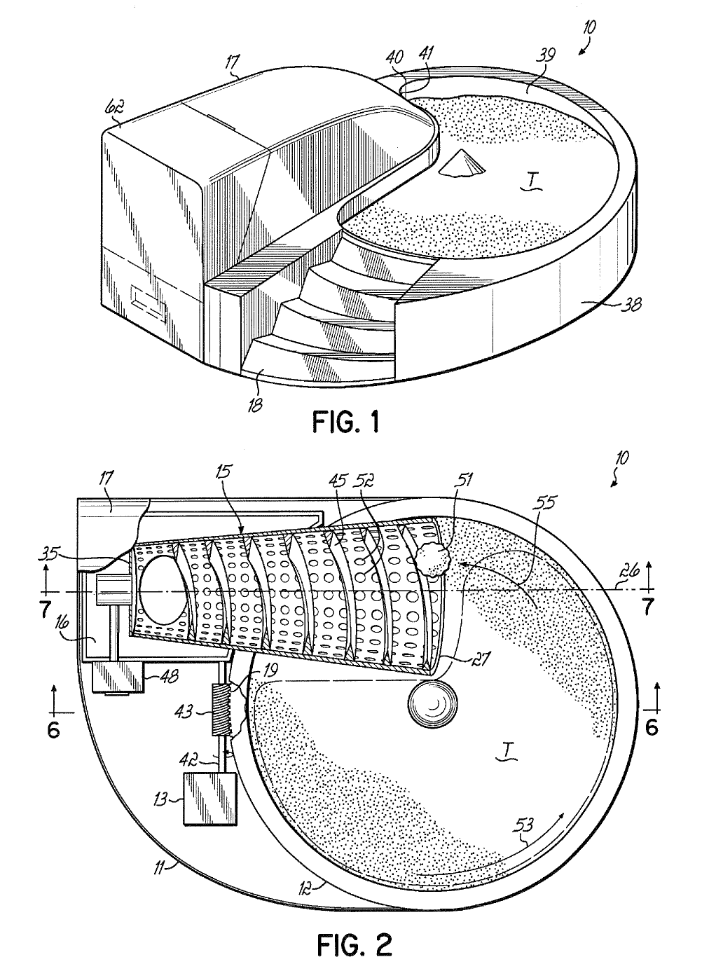

With reference to FIGS. 1-3, a self-cleaning pet litter box assembly 10 comprises a base member 11, an open-top pet litter container 12, a drive mechanism in the form of a motor 13, a conveyor 15, and a waste receptacle 16. The aforementioned components are operably connected such that the litter container 12 continuously or intermittently rotates on a substantially horizontal plane such as one provided by a resting surface and such that any clumped material in the litter container 12 is segregated from unclumped (i.e., clean) litter material and conveyed away. The assembly 10 in this embodiment further includes a series of steps 18 and a cover 17 disposed over the conveyor 15. Alternatively, the assembly 10 may include no steps at all or other components or structures to facilitate ingress and egress of a cat. Similarly, although a cover 17 is depicted, the assembly 10 may alternatively include a cover of a different shape and/or dimensions from those shown or include no cover at all.

The base member 11 is configured to accommodate the pet litter container 12 and the motor 13. The pet litter container 12 fits onto the base member 11 in a manner whereby it can rotate about the pet litter container's center vertical axis and generally on the plane of the base member 11. The motor 13 is thus suitably mounted to the base member 11 and is operatively coupled to the pet litter container 12 to cause rotation thereof. The base member 11 could further include bearing rings 28 to permit smooth relative rotation of the litter container 12 with respect to and over the flat bottom wall 21 of base member 11, as well as a protruding center mount post 22 extending from the flat bottom wall 21 adapted to receive the open-top pet litter container 12 as further described below. The motor 13 is held by the base 11. An enclosure (not shown) for the motor 13, though optional, may be desirable to protect the motor 13 from contaminates.

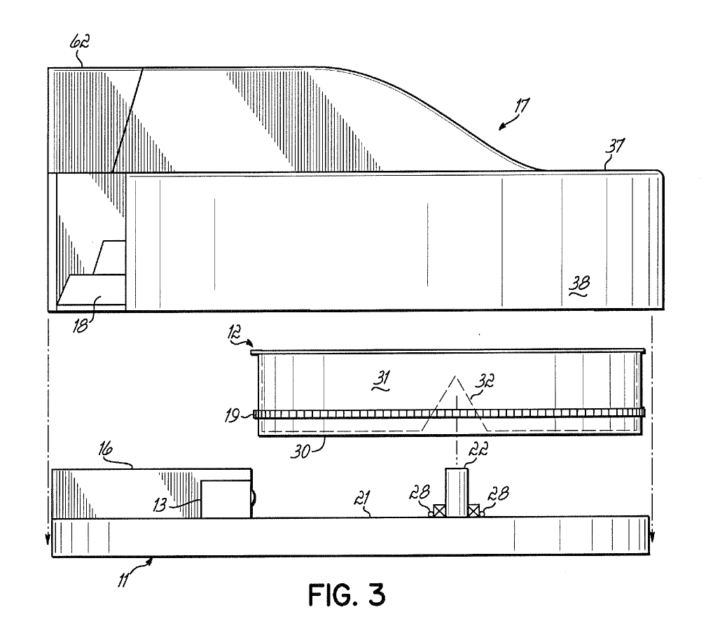

With reference to FIG. 3, the open-top litter container 12 is generally circular, is dimensioned to fit on a generally flat surface 21 of the base member 11 and includes a generally flat bottom wall 30 and upstanding sidewalls 31. The size of the container 12 is such that it can be hand carried and such that it does not occupy excessive space or become conspicuous by its size alone. A container 12 may, for example, be circular-shaped and have a diameter in the range of about fourteen inches to about thirty-six inches and a depth in the range of about three inches to about eight inches. The shape and accompanying dimensions may further be chosen for ease of use and manufacturing reasons.

The open-top pet litter container 12 may have a hollowed cone-shaped center post 32 dimensioned to be guided and overlie the center mount post 22 of the base member 11 such that, when juxtaposed, the base member 11 and litter container 12 are coaxial. Alternatively, the litter container 12 may include a center post of a different shape or include no center post at all. As should be apparent, the litter container 12 is free to rotate on the bearing ring 28 of the base member 11. While not shown, other base member and pet litter container configurations and shapes are feasible. For example, a pet litter container can fit onto a base member which does not have a center mount post. That is, the base member can have a low profile with a substantially flat top surface on which the pet litter container sits. The pet litter container in this alternative configuration is rotationally mounted in one of any known suitable manners, such that the pet litter container is configured to rotate about a vertical axis.

With reference to FIGS. 1-3, the cover 17 for the open-top pet litter container 12 may be desirable to make the self-cleaning pet litter box assembly 10 more aesthetically pleasing and also to help protect moving components of the assembly 10. The cover may, for example, cooperate with the litter container 12 such as to minimize spillage of litter from the litter container 12. The exemplary cover 17 of this embodiment is dimensioned to partially cover the top surface area T of the litter container 12 and includes a top surface 37 and a downwardly turned annular lip 38. The lip 38 extends over the pet litter container 12 by an amount suitable to remain stable, and it may further extend fully to the ground surface on which the assembly 10 rests. An opening 39 in the top surface 37 is sufficiently large to accommodate a cat. As shown in FIG. 1, the opening has an edge 40 that follows the curved edge of the generally circular pet litter container 12 and curved edges 41 extending from the edge 40 to a center of the cover 17. These exemplary sets of edges 40, 41 maybe desirable to provide an aesthetically pleasing appearance as well as to avoid undesirable sharp edges. Other shaped openings are alternatively contemplated, so long as the opening is suitably sized to expose a sufficient amount of the top surface area T of the pet litter container 12. It may, for example, be sized to expose a surface in the range between about 25% and about 75% of the top surface area T of the pet litter container 12.

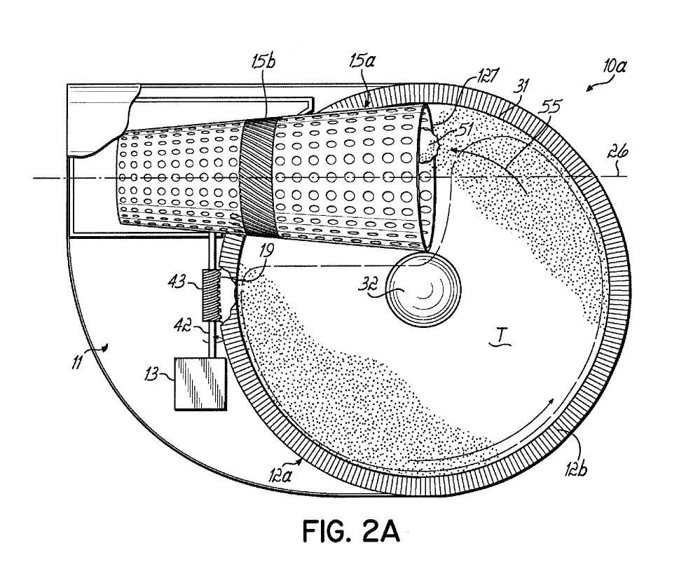

With reference to FIG. 2, the motor 13 is mounted on the base member 11 to provide power to rotate the open-top pet litter container 12. The motor 13 is an electric motor with an electric cord (not shown) for plugging into a conventional wall outlet. Alternatively, the electric motor can be battery powered or may be replaced with a winding device or any other manual or semi-manual device known to those skilled in the art which are capable of rotating motor 13 or the like. A drive shaft 42 extending from the motor 13 operatively connects the motor 13 to the pet litter container 12 to thereby rotate the container 12. A worm gear 43 is mounted on the drive shaft 42 and extends around the sidewalls 31 of the pet litter container 12. Rotary motion of the motor 13 is transferred to the worm gear 43 which is in a meshing relationship with a toothed surface 19 of the container 12. The motor 13 is further geared to cause a relatively slow rotation of the pet litter container 12. Any suitable rotating speed may be chosen for the container 12. For example, rotation having a rate of less than about forty-eight revolutions per day may be desirable as being sufficiently slow that a cat using the assembly 10 does not detect, or at least is not disturbed, by the litter container's motion. Similarly, a rotational speed in the range between about one revolution per day and about thirty-six revolutions per day may be desirable.

The rotation of the pet litter container 12 can be continuous or, alternatively, can be intermittent. For example, at set intervals, the pet litter container 12 can be caused to rotate a full revolution, e.g. one full rotation per hour. A sensor (not shown) can also be used to sense when the cat is on the pet litter box assembly 10 and in response cause the pet litter container 12 to rotate at least one full revolution to separate out and convey away the clumped material 51. Similarly, a sensor may be installed such that it may detect the cat's presence, thereby causing rotation of the container 12 to stop.

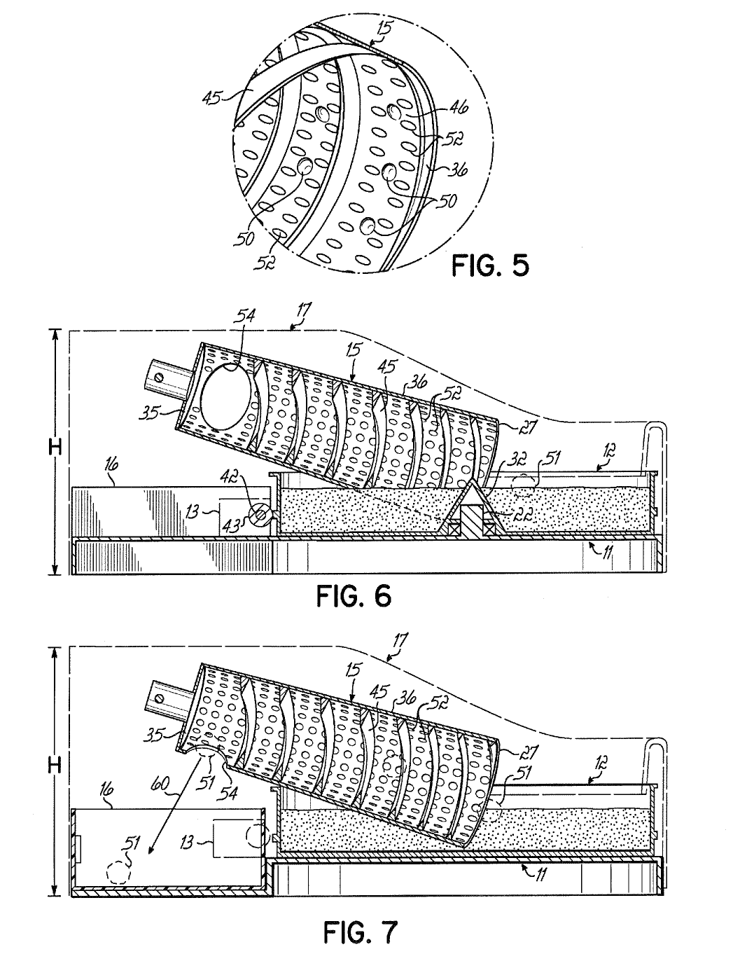

With continued reference to FIG. 2, the assembly 10 includes a rotating conveyor 15 having a longitudinal axis 26, an entrance end 27 proximate the litter in the litter container 12, an oppositely located exit end 35, a drum 36 and a flight in the form of an exemplary helical flight 45 disposed on an inner surface 46 of the drum 36 and substantially extending between the entrance and exit ends 27, 35. With reference to FIGS. 2 and 5, the conveyor 15 is inclined such that the entrance end 27 is lower than the exit end 35, which partially defines the overall height of the assembly 10. Accordingly, the conveyor 15 elevates clumped material away from litter container 12. The helical flight 45 engages and conveys the clumped material away from the entrance end 27 and toward the exit end 35 of the conveyor 15. Conveyor 15 rotates about the longitudinal axis 26 in a direction corresponding with the shape of the helical flight 45 at a suitable speed to permit conveyance of the clumped material 51. Rotation of the conveyor 15 may be continuous or intermittent and is driven, in this exemplary embodiment, by a separate motor 48. Alternatively, conveyor 15 may be driven by motor 13, also driving the container 12, via a suitable gear relationship to permit simultaneous driving of both components 12, 15. For example, FIG. 2A illustrates a self-cleaning pet litter box assembly 10a that includes a conveyor 15a similar to conveyor 15 (FIG. 2) and a container 12a. For ease of understanding, like reference numerals in FIG. 2A refer to like features of FIG. 2. Conveyor 15a includes a toothed band 15b that permits conveyor 15a to be driven by motor 13. To this end, the toothed band 15b engages and cooperates with a toothed surface 12b of container 12a such that rotation of container 12a induces rotation of conveyor 15a. With either of the illustrative embodiments of FIGS. 2, 2A, motors 13 and/or 48 may be powered by alternate current from a conventional electrical outlet, direct current from conventional batteries or via a manual crank assembly (not shown). The conveyor 15 and helical flight 45 may be integrally formed or are otherwise fixedly joined together such that rotation of one causes corresponding rotation of the other.

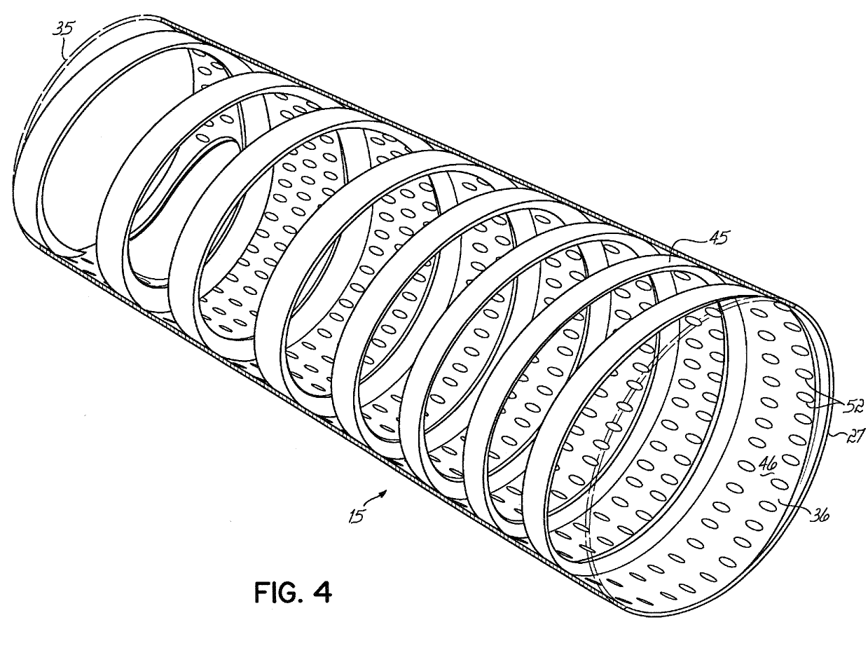

With reference to FIGS. 2 and 4, flight 45 has a suitable cross section, including a height, such that it permits conveyance of the clumped material 51 away from the entrance end 27 and against the force of gravity acting to bias the clumped material toward the entrance end 27. While the flight is depicted as a continuous helical flight 45, persons of ordinary skill in the art will appreciate that, alternatively, the flight may have any other shape including but not limited to a non-continuous flight made up of discrete segments of any suitable shape. The height of the exemplary helical flight 45 varies along the length of the conveyor 15. In this exemplary embodiment, the height is smaller at the entrance end 27 than it is in other portions of the conveyor 15. The smaller height at the entrance end 27 facilitates capturing of the clumped material 51 as the container 12 rotates in the direction shown by arrow 53 and minimizes the likelihood of destruction of the clumped material as it travels from the litter container 12 and into the conveyor 15 following the direction depicted by arrow 55.

Conveyor 15 in the exemplary embodiment of FIGS. 2, 4 is frustoconically shaped but it may alternatively have other shapes including but not limited to cylindrical or compound geometrical shapes, such that it may contain a suitable flight such as a helical flight 45 disposed on an inner surface of a drum defining such alternate conveyor. Conveyor 15 has a diameter at the entrance end 27 effectively extending between the side walls 31 and the center post 32 of the litter container 12, thereby allowing clumped material 51 anywhere along the radius of the container 12 to be captured by the conveyor 15. With reference to FIGS. 6-7, conveyor 15 further extends, in a direction along its longitudinal axis 26, into a predetermined depth of the litter container 12, thereby permitting it to capture clumped material 51 partially or totally buried in the litter material. As described below, this extension of the conveyor 15 into the litter material further permits cup elements 50 situated on the drum 36 to pick up clean litter material. Moreover, by extending the conveyor 15 into the litter material, the required height “H” of the assembly 10 is thereby reduced.

With reference to FIGS. 4-7, conveyor 15 includes apertures 52 extending through the thickness of the conveyor 15. Apertures 52 are sized and arranged to permit clean litter material to pass through and return to the container 12 while not permitting clumped material to pass through, thereby allowing the conveyor 15 to convey the clumped material away toward the exit end 35.

In one embodiment, cup elements 50 are disposed on the inner surface 46 of the drum 36 defining the conveyor 15, generally in an area proximate the entrance end 27. Cup elements 50 are sized and arranged such that they can pick up clean litter material from the container 12 as the conveyor 15 rotates about its longitudinal axis 26. Cup elements 50 are further sized and arranged such that, upon rotation of the conveyor 15, they may release the clean material thereby depositing and coating the outer surfaces defining clumped material 51 with clean litter material previously picked up. Coating of the clumped material 51 may be desirable because it minimizes the amount of sticky material that will adhere to the inner surface 46 of the conveyor 15. While the cup elements 50 are depicted as being integrally formed into the thickness of the drum 36, persons of ordinary skill in the art will appreciate that, alternatively, cup elements 50 may be fixedly or hingedly coupled to any part of the drum 36, so long as they do not interfere with engagement and conveyance of the clumped material 51 respectively into and along the length of the conveyor 15.

With reference to FIGS. 6-7, a drop aperture 54 proximate the exit end 35 of the conveyor 15 serves to remove the clumped material 51 from the conveyor 15 and deposit it in a waste receptacle 16 lying proximate the exit end 35, in the general direction depicted by arrow 60. Drop aperture 54 is suitably sized and shaped to permit passage of the clumped material 51 therethrough when the conveyor 15 rotates to an angular position, such as the one illustrated by FIG. 7, such that the drop aperture 54 generally faces downward. A drop chute 54a in the form of a flexible tube or the like can be attached to the conveyor 15 to be in fluid communication with drop aperture 54. The drop chute 54a extends downwardly and into the waste receptacle 16 to permit transfer of the clumped material 51 from the conveyor 15 to the waste receptacle 16. The drop chute 54a may serve to better confine the clumped material 51 and reduce dust and odor levels in the area surrounding the assembly 10. The waste receptacle 16 is positioned generally under the drop aperture 54 of the conveyor 15 to receive the clumped material 51. Alternatively, the clumped material 51 and pet waste may be conveyed to the exit end 35 of the conveyor 15 in a manner so that the material exits the exit end 35 and drops into the waste receptacle 16.

The exemplary waste receptacle 16 is sized to hold sufficient clumped material 51 such that the pet owner need only empty or replace the waste receptacle 16 on occasion, for example once per week. Needless to say, the greater the capacity of the waste receptacle 16, the less often the pet owner must empty or replace the receptacle. A lid 62 in the back of cover 17 allows access to the waste receptacle 16 to permit disposing of the contents therein. Alternatively, the waste receptacle 16 may be built similar to a drawer (not shown) and have a recessed notch or knob suitable for human fingers to retrieve the receptacle 16 away from the assembly 10 for disposal of the waste therein. The waste receptacle 16 may further be provided with a liner, flexible bag or the like (not shown) to facilitate removal and disposal of the clumped material and solid pet waste.

With reference to FIGS. 1-7, the litter container 12 and conveyor 15 may rotate at the same or different angular velocities. Different speeds may be achieved via separate power sources or, alternatively, if driven by the same power source such as motor 13, via a suitable set of gears connecting the motor 13 respectively to the litter container 12 and conveyor 15. Rotating the conveyor 15 at a speed higher than the speed of the litter container 12 may be desirable because such configuration may eliminate any resistance in the form of mounding of the clumped material. While the exemplary embodiment of FIG. 2 depicts a driving mechanism including a worm gear 43 in a meshing relationship with a toothed surface 19 of the container 12, it should be appreciated that, alternatively, the container 12 could be driven by a motor and belt system as shown in U.S. Pat. Nos. 6,234,112 and 6,401,661 or any other drive system known to those of ordinary skill in the art which is capable of imparting horizontal rotational movement to the pet litter container 12.

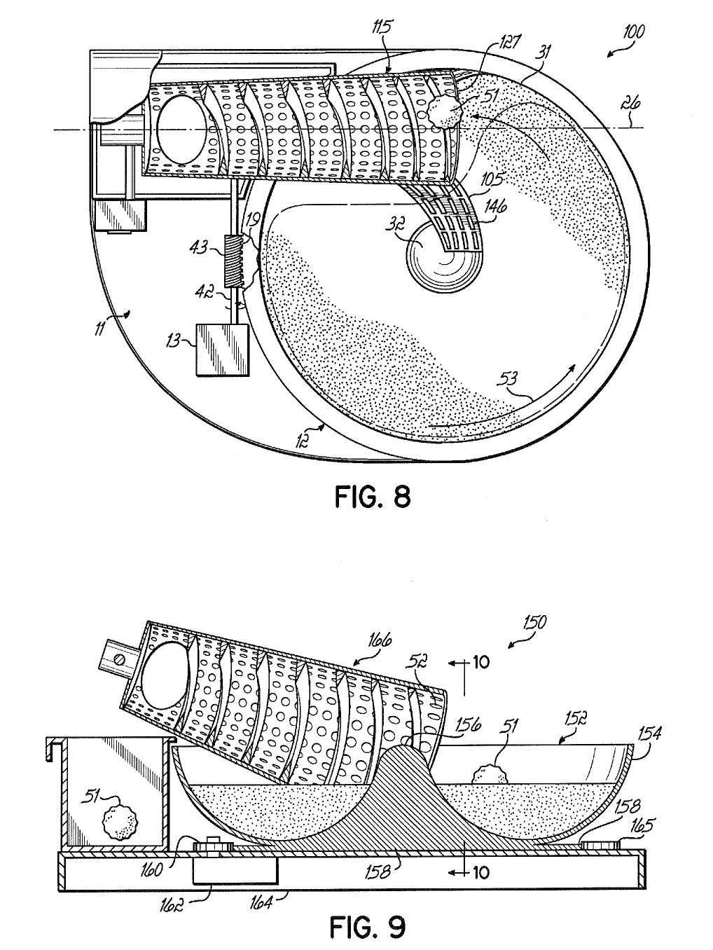

With reference to FIG. 8, in which like reference numerals refer to the like features in FIGS. 1-7, an alternative embodiment of a self-cleaning pet litter assembly 100 includes a conveyor 115 having a narrower entrance end 127 than the entrance end 27 of the assembly 10 (FIG. 2). Assembly 100 includes a sieve member 105 positioned generally adjacent the conveyor 115 and positioned to remain stationary with respect to the base 11 and the conveyor 115. Sieve member 105 provides a transition surface for the clumped material 51 between the container 12 and the conveyor 115. The sieve member 105 in this alternative embodiment is positioned to extend past the top rim of the pet litter container 12 and to terminate at or near the litter container's bottom wall 30 (FIG. 3). Regardless of where the sieve member 105 terminates, it is positioned to contact a substantial portion of the contents of the litter container 12 as the container 12 rotates in the direction indicated by arrow 53. The sieve member 105 is further shaped such that it substantially extends laterally from the sidewall 31 of the pet litter container 12 to at least near the center post 32. The sieve member 105 may have an upwardly curved surface conducive to receiving clumped and clean material and directing it inwardly toward the conveyor 115. Openings 146 in the sieve member 105 are each sized and arranged to retain clumped material 51 while allowing clean material to fall through and back into the litter container 12. Each opening 146 is suitably shaped and dimensioned. The openings 146 may, for example, be rectangular-shaped and have varying lengths in the range between about one inch and about six inches and widths in the range between about 0.1 inches an about 0.4 inches.

The sieve member 105 of this embodiment may take other forms. For example, and although not shown, the sieve member may include fixed grates that facilitate guiding of clumped material to the conveyor 1δ 5. In this regard, the fixed grates cooperate with the conveyor 115 such that they retain clumped material while allowing clean litter to pass through until the clumped material is conveyed away by a flight of the conveyor 115. Other arrangements may include grooves in the conveyor and sieve member which extend through one another to assure cleaning of surfaces on both components.

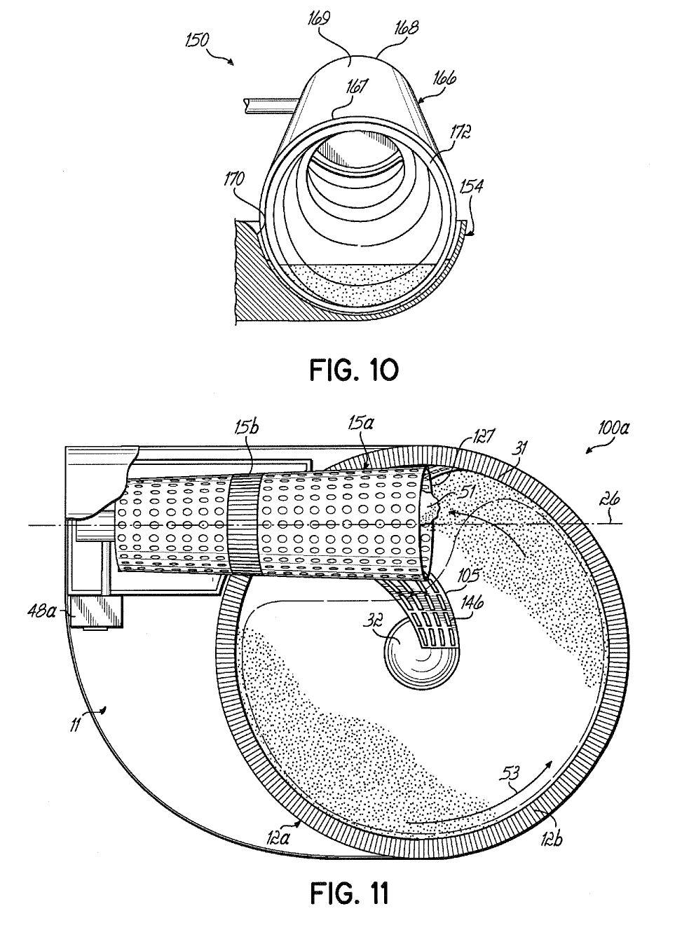

With reference to FIGS. 9-10, in which like reference numerals refer to the like features in FIGS. 1-7, an alternative embodiment of a self-cleaning pet litter assembly 150 includes a pet litter container 152 having a generally semitoroidal outer portion 154 surrounding a raised center portion 156. The litter container 152 includes a toothed surface 158, generally proximate the bottom of the litter container 152, in a meshing relationship with a drive gear 160 driven by a motor 162 located in the body of a base 164. In this exemplary embodiment, a set of idler gears or rollers 165 may be placed on the base 164 such that they may guide the rotational trajectory of the litter container δ 52. The idler gears or rollers δ 65 permit rotation of the litter container on the plane of the base δ 64 without the need for a center post protruding from the base 164.

While the litter container 152 is depicted driven as described above, persons or ordinary skill in the art will appreciate that, alternatively, litter container 152 may be driven in any other suitable methods and/or components including but not limited to worm gears, belts, and the like.

With reference to FIG. 10, the pet litter assembly 150 includes a conveyor 166 including entrance and exit ends 167, 168 and a drum 169, similar to the conveyor 15 (FIGS. 1-7), the description of which may be referred to for an understanding of the conveyor 166 as well. The shape and outer diameter of the entrance end 167 of conveyor 166 are such that they closely match the top surface 170 defining the semitoroidal outer portion 154 of the litter container 152, thereby substantially forcing all of the clumped material and clean litter material into the conveyor 166, which separates the clean litter material from the waste.

Conveyor 166 further includes a flight 172, similar to the flight 45 of FIGS. 4-5, disposed on the inner surface of the drum 169 defining the conveyor 166. The height of the flight 172 near the entrance end 167 is substantially negligible and it gradually increases at least along a portion of the length of the conveyor 166, such that it reaches a height between about 2 inches and about 6 inches in other portions of the conveyor 166. Advantageously, this height distribution permits a very gentle initial contact of the clumped material, which is desirable because clumped material may tend to be easily broken up. Persons of ordinary skill in the art will appreciate that conveyor 166 may be made to rotate clockwise or counterclockwise, at any suitable speed, in accordance with the specific design of the flight 172.

With continued reference to FIGS. 9-10, the exemplary self-cleaning pet litter assembly 150 shown therein provides a conveyor 166 with a relatively larger filter surface area and with a relatively longer conveyance time than those provided by known devices, thereby improving the process of separation between clumped material 51 and clean litter material. Moreover, the gradual gentle initial contact between the conveyor and the clumped material 51, as well as the relative speeds between the conveyor 166 and litter container 152 permits the avoidance of mounding (e.g. the formation of a “standing wave”) of the clumped material 51 near the entrance end 167 of the conveyor 166. The avoidance of such mounding permits the disposition of apertures 52 along the conveyor 166 smaller than similar filtering apertures of known devices, such that an improved filtering process can be effected.

With reference to FIG. 11, in which like reference numerals refer to like features of FIGS. 2A and 8, an alternative embodiment of a self-cleaning pet assembly 100a is similar in most respects to assembly 100 (FIG. 8), the description of which may be referred to for an understanding of assembly 100a as well. Assembly 100a includes container 12a and a conveyor 115a, both driven by a single motor 48a. In this regard, conveyor 115a has a toothed band 15b that engages and cooperates with a toothed surface 12b of container 12a such that rotation of conveyor 115a induces rotation of container 12a.

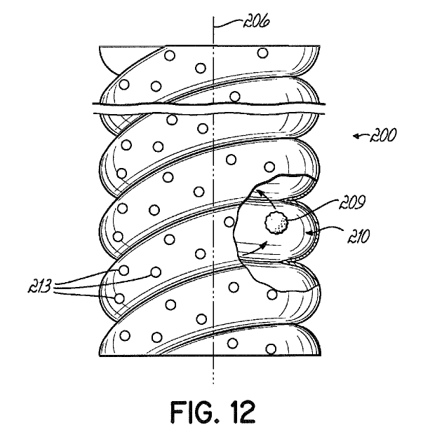

With reference to FIG. 12, an alternative embodiment of a conveyor 200 can be used with other features of any of the above embodiments of the pet litter box assemblies of FIGS. 1-11. Conveyor 200 is in the form of a helical or spiraling conveyor formed, for example, from a spiraling or helical tube having a longitudinal portion removed. Conveyor 200 similarly defines an axis 206 about which conveyor 200 rotates to thereby convey clumped material 209 away from a litter container. Conveyance of the clumped material 209 is such that the clumped material is received within a continuous channel 210 of the conveyor and retained therein during travel of the clumped material 209 away from the litter container. In this exemplary embodiment, the channel 210 has a generally U-shape cross-section although this is merely illustrative, as the channel may have a cross-section having any other shape suitably chosen to convey the clumped material 209 away. Conveyor 200 includes apertures 213 that permit passage of clean litter there through from the channel 210 to the litter container while the clumped material is conveyed away from the litter container.

While the conveyor 200 is depicted defining a generally constant cross-sectional width, it is contemplated that it may instead have a varying cross-sectional width. For example, conveyor 200 may instead have a cross-sectional width that gradually tapers towards or away from the litter container. Likewise, it is contemplated that the conveyor 200 may instead have a step change in cross-sectional width.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

For example, while all figures depict respective conveyors having axes of rotation that are inclined at an angle relative to the top surface area T of the litter container (FIG. 1), other axes of rotation are contemplated. For example, and without limitation, an axis of rotation for a conveyor may be substantially perpendicular to the top surface area T of the litter container. Similarly, an axis of rotation may be horizontal i.e., substantially parallel to the top surface area T of the litter container. Likewise, while the above embodiments depict conveyors having a single axis of rotation, it is contemplated that a conveyor may have more than one axis of rotation. For example, a universal joint or the like may couple different portions of a conveyor to one another such that the conveyor may rotate simultaneously about more than one axis of rotation. Accordingly, such embodiment would permit, for example, a conveyor having a first portion that is generally angled relative to the top surface area T of the litter container and a second portion that is substantially horizontal (i.e., generally parallel to the top surface area T of the litter container). Likewise also, while all conveyors of FIGS. 1-12 are depicted having either a generally constant cross-sectional width or a cross-sectional width that gradually changes or tapers, it is contemplated that a conveyor may instead have a step change in its cross-section. More particularly, for example, a conveyor may be such that it has a generally constant or gradually changing cross-sectional width in a first portion thereof, and another generally constant or gradually changing cross-sectional width in a second portion, where the first and second portions define a step change in cross-sectional width between them (e.g., approximating a T-shape conveyor).

What is claimed is:

1. A self-cleaning pet litter box assembly for separation and removal of clumped material from clean litter material, comprising:
an open-top pet litter container for holding litter, said container being mounted for rotation on a substantially horizontal plane;
a conveyor having an axis and an exit end, said conveyor being positioned to extend into said container to contact litter therein, rotation of said conveyor about said axis configured to separate clumped material from the clean litter material and direct the separated-out clumped material away toward said exit end; and
a drive mechanism operatively connected to at least one of said container and said conveyor to rotate said container and said conveyor.

2. The litter box assembly of claim 1, wherein said conveyor is one of frustoconically shaped or cylindrically shaped.

3. The litter box assembly of claim 1, wherein said conveyor includes an entrance end disposed opposite said exit end, said container including a center and at least one side wall, said entrance end extending effectively between said center and said at least one side wall.

4. The litter box assembly of claim 1, wherein said conveyor includes an inner surface and a flight protruding from said inner surface, said flight configured to convey the clumped material toward said exit end.

5. The litter box assembly of claim 4, wherein said flight is helically shaped.

6. The litter box assembly of claim 4, wherein said conveyor includes an entrance end disposed opposite said exit end, said flight extending substantially between said entrance end and said exit end.

7. The litter box assembly of claim 4, wherein a height of said flight varies along at least a portion of a length of said conveyor.

8. The litter box assembly of claim 7, wherein the height of said flight proximate said entrance end is less than the height thereof in other portions of the conveyor.

9. The litter box assembly of claim 1, wherein said conveyor includes a plurality of apertures configured to retain clumped material while permitting clean litter material to pass therethrough.

10. The litter box assembly of claim 1, wherein said conveyor includes an entrance end and a plurality of cup elements disposed proximate said entrance end and configured to pick up the clean litter material from said container and deposit it onto clumped litter material within said conveyor.

11. The litter box assembly of claim 10, wherein said conveyor includes a plurality of cup elements formed in said conveyor.

12. The litter box assembly of claim 1, wherein said drive mechanism is operatively connected to said conveyor for rotating said conveyor.

13. The litter box assembly of claim 12, wherein said drive mechanism is configured to rotate said container at a speed different from that of said conveyor.

14. The litter box assembly of claim 1, wherein said drive mechanism is configured to rotate said container at a speed lower than that of said conveyor.

15. The litter box assembly of claim 1, wherein said drive mechanism is configured to rotate at least one of said container and said conveyor continuously.

16. The litter box assembly of claim 1, wherein said drive mechanism is configured to rotate at least one of said container and said conveyor intermittently.

17. The litter box assembly of claim 1, wherein said container includes a toothed surface and said conveyor includes a toothed band in meshing cooperation with said toothed surface such that rotation of one of said container and said conveyor rotates the other of said container and said conveyor.

18. The litter box assembly of claim 17, wherein said drive mechanism includes a single motor configured to rotate one of said container and said conveyor such that engagement of said toothed surface with said toothed band causes rotation of the other of said container and said conveyor.

19. The litter box assembly of claim 1, wherein said conveyor includes an opening proximate said exit end, said opening configured to permit clumped material directed away by said conveyor to pass through said conveyor.

20. The litter box assembly of claim 19, further comprising:
a waste receptacle disposed proximate said exit end and configured to receive clumped material from said conveyor.

21. The litter box assembly of claim 20, further comprising:
a connector fluidly communicating said conveyor and said waste receptacle to transport the clumped material from said conveyor to said waste receptacle.

22. A self-cleaning pet litter box assembly for separation and removal of clumped material from clean litter material, comprising:
an open-top pet litter container for holding litter, said litter container being mounted for rotation on a substantially horizontal plane;
a rotating conveyor having an axis, an entrance end, and an exit end, said conveyor being positioned to extend into said container to contact litter therein, rotation of said conveyor about said axis configured to separate clumped material from the clean litter material; and
a flight disposed within said conveyor, having a varying height along a length of said conveyor, and extending between said entrance end and said exit end, said flight configured to convey the clumped material toward said exit end.

23. A self-cleaning pet litter box assembly for separation and removal of clumped material from clean litter material, comprising:
an open-top pet litter container for holding litter, said litter container being mounted for rotation on a substantially horizontal plane; and
a spiraling conveyor having an axis and an exit end, said conveyor being positioned to extend into said container to contact litter therein, rotation of said spiraling conveyor about said axis configured to separate clumped material from the clean litter material and direct the separated-out clumped material away toward said exit end.

24. A self-cleaning pet litter box assembly for separation and removal of clumped material from clean litter material, comprising:
an open-top pet litter container for holding litter, said litter container being mounted for rotation on a substantially horizontal plane; and
a spiraling conveyor having an axis and an exit end, said conveyor being positioned to extend into said container to contact litter therein and including a channel, rotation of said spiraling conveyor about said axis configured to retain the clumped material within said channel and direct it away toward said exit end.

25. A method of automatically separating and removing clumped material from clean litter material, comprising:
rotating an open-top pet litter container to bring the clumped and clean litter material into engagement with a conveyor;
rotating the conveyor to direct the clumped material and clean litter material away from the container;
directing the clean litter material through a plurality of openings of the conveyor and into the container.
